(19) United States
(12) Patent Application Publication
(10) Pub. No.: US 2014/0039996 A1
(43) Pub. Date: Feb. 6, 2014

(54) ELECTRONIC NETWORK MARKETING SYSTEM AND METHOD FOR DISTRIBUTING DIGITAL CONTENT OVER AN ONLINE SOCIAL NETWORK

(71) Applicant: Alberto Interian, III, Miramar, FL (US)

(72) Inventor: Alberto Interian, III, Miramar, FL (US)

(21) Appl. No.: 14/113,195

(22) PCT Filed: Apr. 20, 2012
(86) PCT No.: PCT/US12/34561

§ 371 Date: Oct. 21, 2013

Related U.S. Application Data
(60) Provisional application No. 61/477,374, filed on Apr. 20, 2011.

(51) Int. Cl. G06Q 50/00; G06Q 30/02

(52) U.S. Cl. CPC G06Q 50/01; G06Q 30/0214
USPC 705/14.16

(57) ABSTRACT

A system comprising at least processor and computer executable instructions readable by the at least one processor and operative to distribute a piece of content to a first user of a social network, allow the first user to endorse the piece of content on his or her user profile, allow a second user of the social network to access the first user's profile, allow the second user to purchase rights to access the piece of content through the first user's profile, distribute a commission to the first user if the second user purchased the piece of content based on the first user's endorsement, and allow the second user to endorse the piece of content on his or her user profile.

### PRIORITY CLAIM

The present application is a non-provisional patent application of U.S. provisional patent application Ser. No. 61/477,374, filed on Apr. 20, 2011, titled “Network Marketing System and Method for Distributing Media Over Social Networks,” by Alberto Interian III, to which the present application claims priority, and which is hereby incorporated by reference as if fully stated herein.

### FIELD

The present disclosure relates generally to electronic systems and methods, and more specifically to electronic systems and method for the distribution of digital content, such as music, movies, and text material.

### BACKGROUND

In recent years, the landscape of content distribution has changed dramatically. Up until a few years ago, the primary means for distributing content comprised of selling hard copies, such as music CDs and movie DVDs, through brick-and-mortar stores and other retail outlets. Traditional movie theatres have remained a viable means of distributing content as well.

With the rise in internet usage that occurred in the late 1990's, many consumers began to consume content through digital means, such as the downloading and streaming of content. This gave way to a huge increase in content piracy, since digital content is easily copied and distributed over computer networks, such as peer-to-peer (“P2P”) networks. More recently, torrent downloads have become the primary means of content piracy (and distribution, albeit illegal).

The content distribution industry has attempted to curb online content piracy by offering legitimate means for obtaining digital content, such as online content stores, which includes well known services like Apple iTunes, and Amazon.com. Despite these efforts, content piracy via digital distribution networks continues to rise, particularly torrent sharing and downloads, and continues to plague the content production and distribution industry by causing billions of dollars of losses each year.

### SUMMARY

The systems and methods described herein result from the realization that piracy of digital content may be curbed by providing a network marketing system and method for distributing digital content over online social networks, thereby offering consumers a means to monetize their content libraries by taking part in a network marketing structure for distributing digital content over online social networks.

Accordingly, the various embodiments and disclosures described herein solve the limitations of the prior art in a new and novel manner.

### BRIEF DESCRIPTION OF THE DRAWINGS

FIG. 1A shows a system in accordance with one embodiment;

FIG. 1B shows a system in accordance with another embodiment;

FIG. 1C shows a system in accordance with another embodiment;

FIG. 1D shows a system in accordance with yet another embodiment;

FIG. 1E shows a user profile, or user profile page in accordance with on embodiment;

FIG. 1F shows an electronic social network marketing structure for distributing content in accordance with one embodiment;

FIG. 1G shows an electronic social network marketing structure for collecting and distributing commissions in accordance with one embodiment;

FIG. 2 shows a system in accordance with one embodiment;

FIG. 3 shows a block diagram depicting a method in accordance with one embodiment; and

FIG. 4 shows a block diagram depicting an apparatus in accordance with one embodiment.

### DETAILED DESCRIPTION

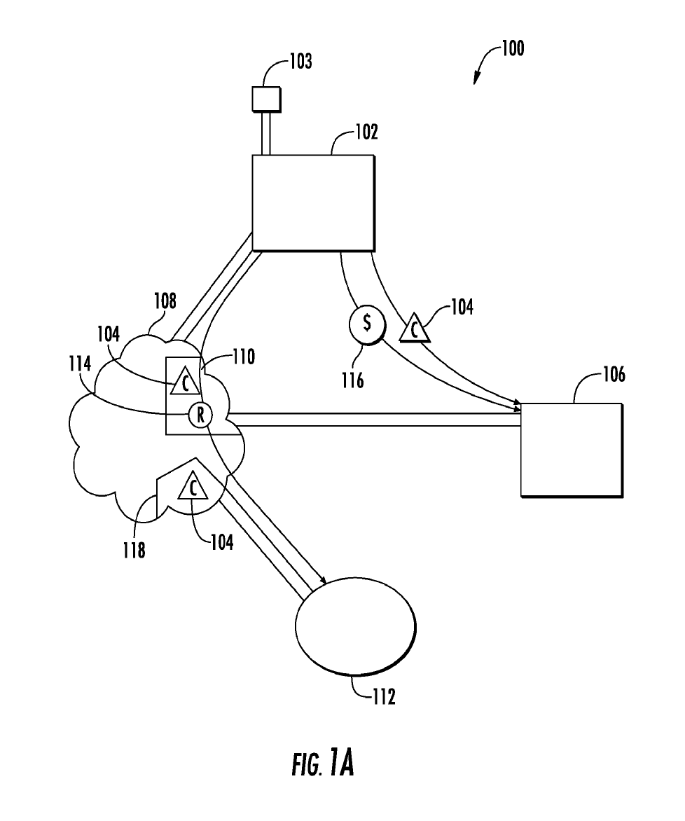

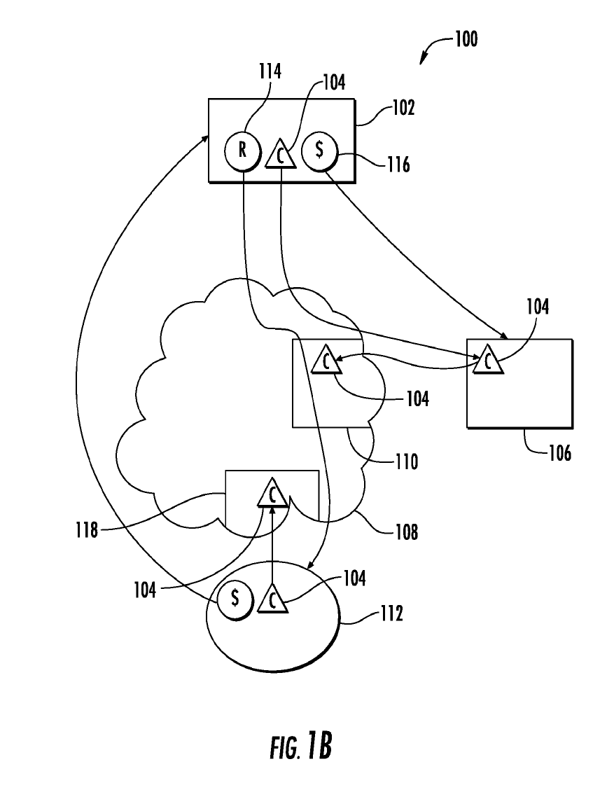

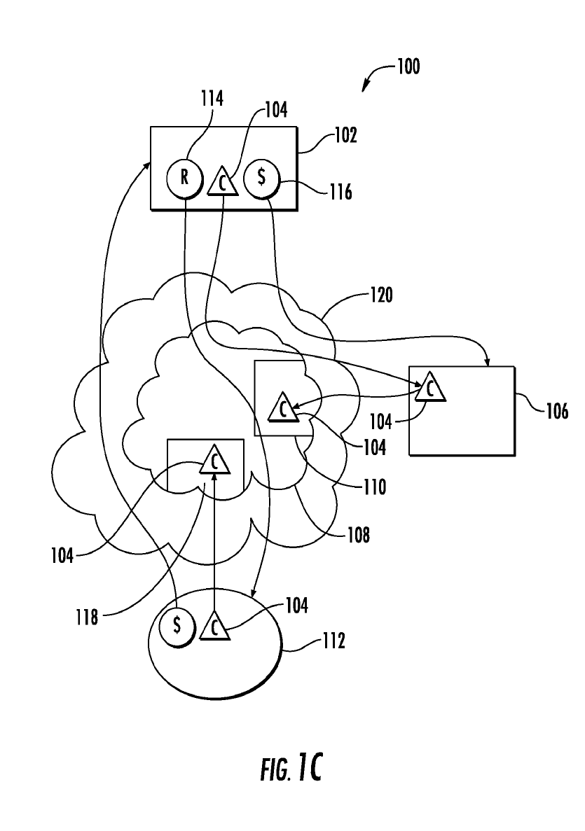

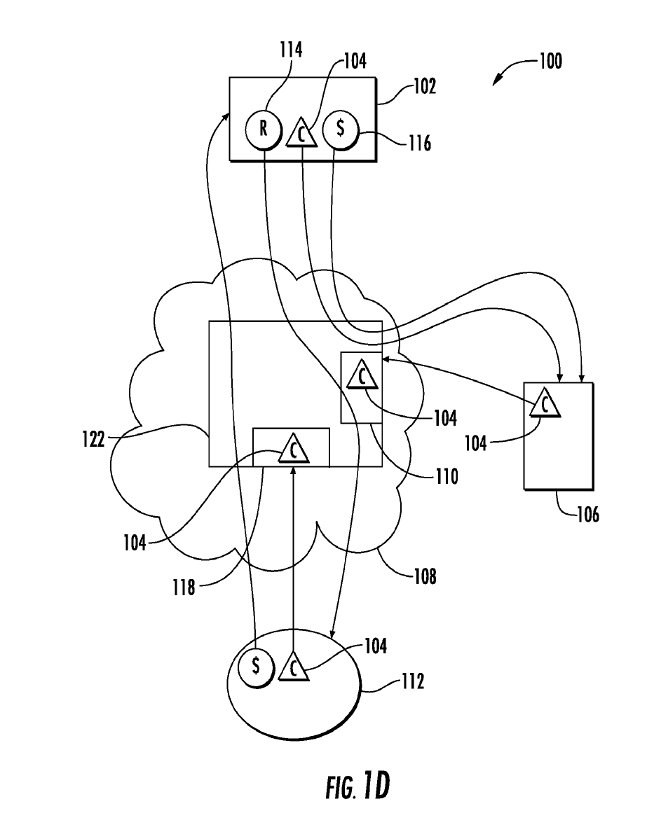

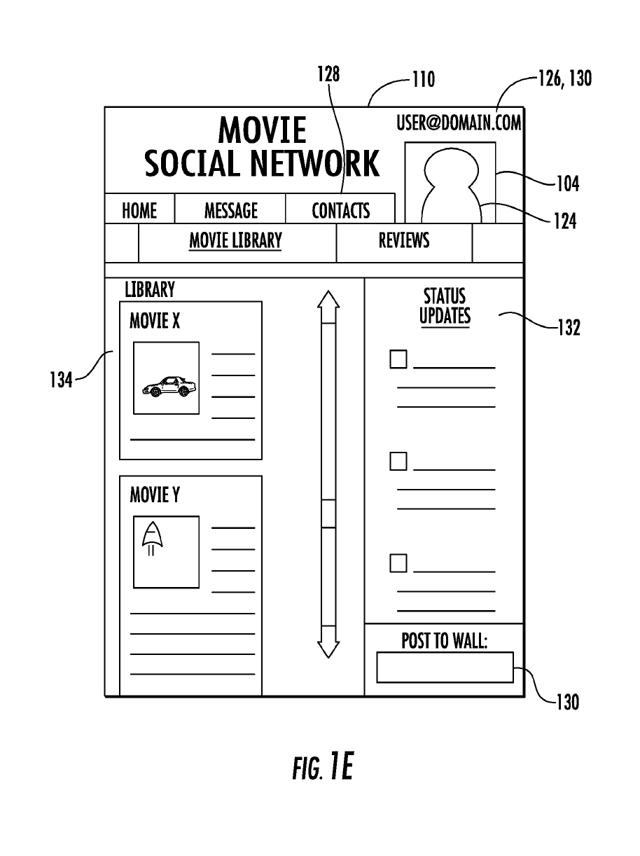

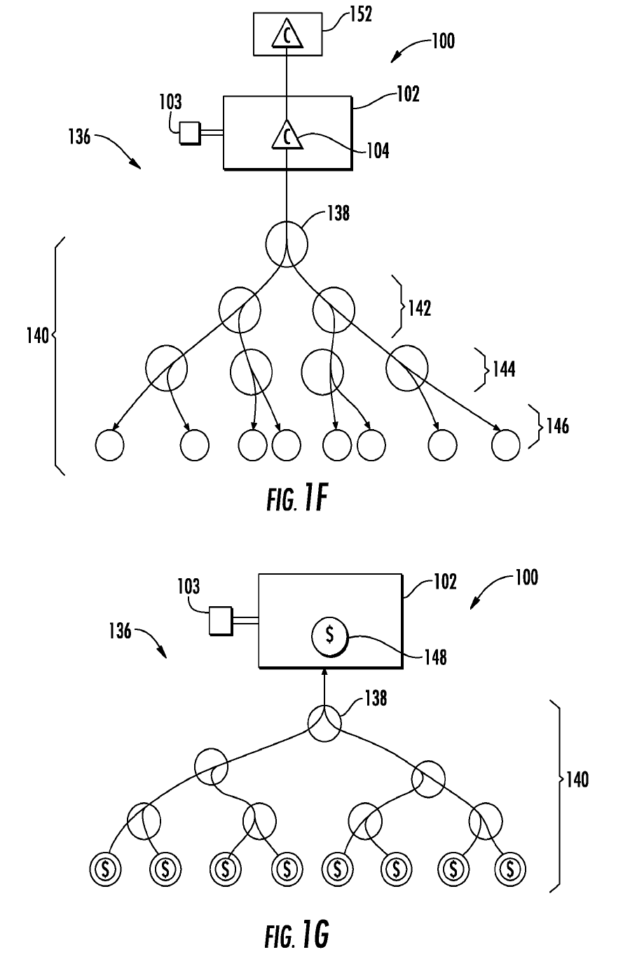

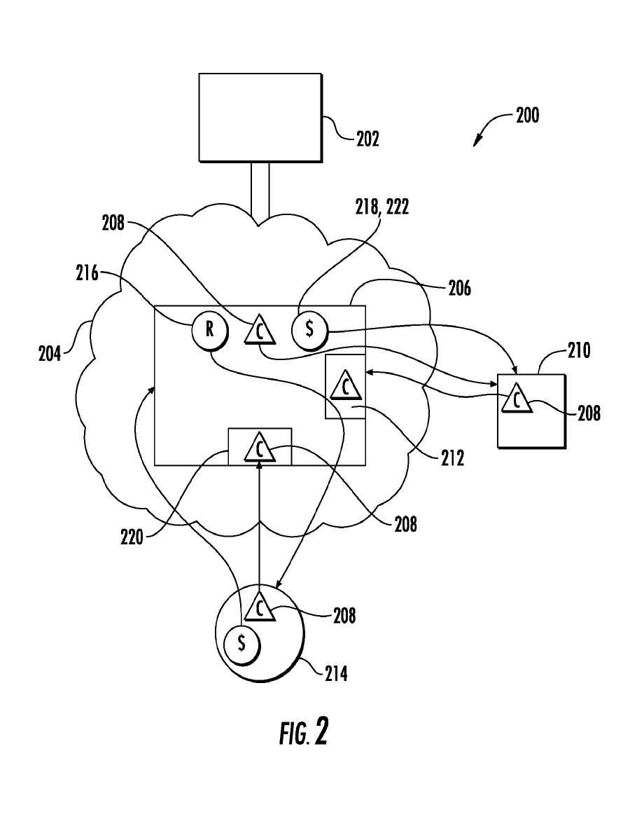

FIG. 1A shows a system 100, in accordance with one embodiment, wherein system 100 comprises at least one processor 102, and computer executable instructions 103 readable by at least one processor 102 and operative to distribute a piece of content 104 (which may hereinafter be referred to simply as “content 104”) to a first user 106 of a social network 108, allow first user 106 to endorse content 104 on his or her user profile 110, allow a second user 112 of social network 108 to access first user's profile 110, allow second user 112 to purchase rights 114 to access piece of content 104 through first user's profile 110, distribute a commission 116 to first user 106 if second user 112 purchased content 104 based on first user 106's endorsement, and allow second user 112 to endorse content 104 on second user 112's user profile 118.

In some embodiments, at least one processor 102 may be any type of processor, such as, but not limited to a computer processor, a server processor, a mobile device processor, such as, but not limited to, a single core processor or a multi-core processor.

At least one processor 102 may be connected to, part of, or integrated with a server that hosts social network 108. In yet another embodiment, at least one processor 102 may be connected to, part of, or integrated with a server that distributes content 104, such as, but not limited to, a content distribution network server, a streaming media server, and the like. In some embodiments, at least one processor 102 may be connected to, part of, or integrated with a server that hosts a social network application that distributes the content, such as an application that operates with a social network. In yet another embodiment, at least one processor 102 may comprise multiple processors, wherein each processor may be connected to, part of, or integrated with various servers, such as a content distribution server, a social network server, or a social network application server, wherein said severs operate in conjunction to provide the various aspects of system 100, such as providing social network 108, distributing content 104, distributing commission 116, managing user accounts, providing a social network application, and the like; alternatively, at least one processor 102 may manage the these various components of such as system.

As used herein, the terms “connected,” “part of,” or “integrated with,” should be interpreted as referring to an electronic connection or integration, which allows for electronic communication between two electronic components. Said electronic connection may comprise a wireless electronic connection, wired electronic connection, combination thereof, or direct electronic connection, such as in the case with various components that share the same electronic circuit board. In alternate embodiments, said electronic connection may comprise a remote or indirect electronic connection that is enabled by a computer network connection, or a direct connection that is enabled through local wireless communications means (e.g. WiFi, Bluetooth, etc.), through wired communication means, or through sharing a same electronic circuit board.

In some embodiments, computer executable instructions 103 may comprise computer language or other means for embodying computer executable instructions, such as C, C++, C#, Java, Flash, HTML, HTML 5, and the like. Computer executable instructions 103 may be stored on any digital storage means, such as a computer readable medium, which may include a hard drive, flash storage, a CD-ROM, a DVD, and the like. Computer executable instructions 103 may be accessed by processor 102 via a local connection, such as by being directly connected to a computer readable medium in which computer executable instructions 103 are stored, or via a remote connection, such as via a computer network connection.

In some embodiments, distributing content 104 to first user 106 comprises electronically distributing content 104 to first user 106. Distributing may comprise streaming content 104 to first user 106, allowing first user 106 to download content 104, or providing user 106 with rights to access content 104, such as access via a computer network. In some embodiments, distributing content 104 to first user 106 may comprise allowing first user 106 to view content 104 or an endorsement of content 104 on one of first user 106's social network contact's user profile.

In one embodiment, content 104 may be distributed outside of social network 108, as shown in FIG. 1A. Alternatively, content 104 may be distributed through social network 108, as shown in FIG. 1B. In another embodiment, content 104 may be distributed outside of social network 108, but within a computer network 120 (such as the internet) wherein social network 108 resides or is accessed, and which connects processor 102, first user 106, and second user 112, as shown in FIG. 1C. In yet another embodiment, content may be distributed via a social network application 122 (commonly referred to as an “app”) that operates within social network 108, as shown within FIG. 1D. Accordingly, content 104 may be distributed in a social network that exists primarily, or revolves around, the distribution, sharing, marketing, and discussion of content 104, and other content. Alternatively, content 104 may be distributed in a social networking application that operates or resides within a more general social network, wherein said social networking application may revolve around the sharing, distribution, marketing, and discussion of content 104, while the general social network within which the application operates may be for general social networking, such as is this case with Facebook™

In one embodiment, distributing content 104 to first user 106 comprises allowing first user 106 to purchase content 104. Alternatively, distributing content 104 to first user 106 comprises distributing content 104 to first user 106 for free (or free of charge). In a further embodiment, distributing content 104 to first user 106 may comprise distributing content 104 to first user 106 for free so long as first user 106 is an influential user of social network 108. The term “influential social network user,” as used herein, may refer to a user of a social network that has a relatively large network of social network contacts, wherein “relatively large” may be interpreted as having more social network contacts than the average user of the social network. Alternatively, distributing content 104 to first user 106 for free may be done so as long as first user 106 has a certain or pre-determined number of social network contacts. Said certain or pre-determined number of social network contacts may be any number, such as, but not limited to, one thousand (1,000).

In one embodiment, content 104, may comprise digital content, or a piece of digital content. The term “content,” as used herein, may refer to any type of content, such as, but not limited to, movies, music, books, magazines, novels, home made movies, user generated content, and the like.

In one embodiment, social network 108 may be any type of social network, such as but not limited to, a social networking website. In another embodiment, social network 108 may be dedicated primarily to, or revolve around, the distribution, marketing, sharing or discussing of content 104, or content in general. In yet another embodiment, social network 108 may comprise a general social network, such as, but not limited to, a type of social network similar to Facebook™, which is dedicated only to facilitating social networking interactions, and no other purpose.

In some embodiments, social network 108 may be accessed via any type of computing device, such as, but not limited to, a PC, a tablet PC, a mobile PC, a smartphone, a handheld PC, and the like.

In one embodiment, allowing first user 106 to endorse content 104 on first user 106's profile 110 may comprise allowing first user 106 to endorse content 104 to first user 106's social network contacts.

The term “user profile,” as used herein may refer to a web page (as shown in FIG. 1E), or a landing page, representing a social network user, such as user 106, which may include various information, such as photos 124, contact information 126, social network contact (commonly referred to as “friend”) list 128, means for contacting a user 130, a user status update section 132 or “wall,” and other various sections of a user profile. Accordingly, endorsing content 104 may comprise posting an endorsement of content 104 on a status update section, or a section dedicated to content endorsement, such as a content endorsement wall or content library 134. In another embodiment, endorsing content 104 may comprise automatically adding content 104 to first user 106's content library section 134, which may be displayed on profile 110. In yet another embodiment, the section of profile 110 dedicated to endorsing content 104, or simply dedicated to content in general, may actually be part of a social network application that first user 106 may opt-into.

Accordingly, computer executable instructions 103 may be operative to display a content library on first user 106's profile 110, wherein the content library may list content 104 or displays a link to content 104, or other information associated with content 104, such as bibliographical information, user reviews, including review by user 106, and the like. In some embodiments, the endorsement may comprise a web link, a visual code, such as a bar code or quick-read code (“QR Code”), a review of content 104, a pre-view or thumbnail of content 104, and the like. In some embodiments, the endorsement may comprise a review authored by first user 106, wherein first user 106 may try to encourage or discourage his or her social network contacts from purchasing content 104.

In one embodiment, upon accessing first user 106's endorsement, computer executable instructions 103 may be operative to present second user 112 with an option to purchase content 104, and credit first user 106 for the sale, for which first user 106 may receive commission 116.

In some embodiments, allowing second user 112 to purchase rights 114 to access content 104 through first user 106's profile 110 comprises allowing second user 112 to purchase rights 114 to download or stream content 104. The term “purchase rights to access content” may be used interchangeably with “purchase content.”

In some embodiments, distributing commission 116 to first user 106 may comprise distributing a monetary commission to first user 106, or distributing a credit-based commission to first user 106. A monetary commission may be distributed electronically, such as through an electronic transfer funds, or physically, such as by mailing a check via a courier or postal service. A credit-based commission may comprise of electronic credits, which although non-monetary, may be used by first user 106 to purchase products or services on social network 108 or within social network application 122, which may include additional content. In some embodiments, the credit-based commission may be exchanged for money. Commission 116 may be any number, including a pre-determined amount. Alternatively, commission 116 may be a percentage of the sale, wherein said percentage may be any amount. In some embodiments, the proceeds of the sale may divided into commission 116, a payment to an operator of social network 108, social network application 122, of system 100, distributor of content 104, owner, producer, or rights holder of content 104, any “up-line” distributors, and the like. The term “up-line” distributor will be defined below, where the network marketing structure is further discussed.

Accordingly, computer executable instructions 103 may be operative to distribute a fee to a content distributor whenever content 104 is purchased. The content distributor may be any kind of distributor, such as a regional distributor, digital distributor, a studio, a production house, an up-line distributor, an operator of system 100, and the like.

In embodiments, computer executable instructions 103 may be operative to require first user 106 to install, open, access, opt into, or authorize social networking application 122 prior to distributing content 104 to first user 106. In some embodiments, first user 106 may be required to install, open, access, opt into, or authorize social networking application 122 in situations where content 104 is distributed, marketed, discussed, purchased, accessed, or otherwise dealt with in social networking application 122 that operates within social network 108. Accordingly, social networking application 122 may operate within a social networking environment, such as social network 108.

In yet another embodiment, computer executable instructions 103 may be operative to require second user 112 to open, access, opt into, install, or authorize social network application 122 prior to purchasing content 104.

The terms “open,” “access,” “opt into,” or “install,” as used above, may refer to the action of prompting a user to authorize social network application 122 to access their user information on social network 108, to make changes to their user profiles, to post information (automatically or when prompted) on their user profiles, and to market content to their user contacts. Many social networks require users to authorize a social network application prior to allowing the user to access the application, and allowing the application to access the user's information. This may require having the user agree to certain terms and conditions.

In one embodiment, computer executable instructions 103 may be operative to host a digital rights management system to manage the distribution of content 104 and prevent unauthorized access, distribution, or copying of content 104. Such digital rights management system may comprise various mechanisms, such as a digital rights server that communicates with digital rights clients operating on user devices or in social network 108 or social networking application 122, digital rights keys, content encryption, and the like. The digital rights management system may comprise any type of digital rights management system, such as those developed by Widevine™, Civolution™, Verimatrix™, and the like.

In yet another embodiment, computer executable instructions 103 may be operative to allow first user 106 or second user 112 to link their social network 108 account with a third party social network provider. That way account information may be shared between social networks.

The aforementioned embodiments of system 100 may be used to electronically distribute content in a social network using a network marketing structure (also referred to as “multi-level marketing”) that leverages the connections between users 138 of the social network and their social network contacts. Referring now to FIGS. 1F and 1G, various embodiments of system 100 are shown wherein at least one processor 102 and computer executable instructions 103 may be operative to electronically distribute content 104 in social network 108 using a network marketing structure that leverages the connections between users of social network 108.

In some embodiments, content 104 may be distributed or seeded to a user 138 at a top of a distribution network 140, who in turn may distribute content 104 to their social network contacts 142, who in turn, may distribute content 104 to their social network contacts 144, who in turn may distribute it to their social network contacts 146, and so on and so forth. User 138 may comprise first user 106, while one of the social network contacts/users 138, 142 may comprise second user 112.

For example, if users 142 sells content 104 to their social network contacts 144, users 144 may earn commissions 148 from the proceeds of that sale, and a commission may also be distributed to all of users 142's distribution upline, which in this case, includes user 138. Accordingly, if users 144 distribute or sell content 104 to their social network contacts 146, then users 144, 142, and 138 may all collect commissions since the sale was in their downline. The terms “upline” and “downline,” as used herein, may refer to persons, in this case, users, who are above or below a certain person in the network marketing organization or structure, also commonly referred to as a “genealogy” of distributors. For example, in FIGS. 1F and 1G, users 138, 142, and 144 are in users 146's upline, and users 142, 144, and 146 are in user 138's downline. Typically, users may collect commissions from their direct downline. In some embodiments, commissions may only be collected up to a certain level of the downline structure. Furthermore, the further down the downline the sale occurs, the smaller the commission a user earns.

Ultimately, however, operator 150 of system 100, which uses processor 102 and computer executable instructions 103 to implement the network marketing system earn proceeds from each sale of the content, no matter how far downline each sale occurs. Furthermore, a commission or royalty may also be paid to a content owner or distributor 152 who provides operator 150 with content 104.

In this manner, content 104 may be distributed with limited marketing and advertising costs, since the marketing is all done by the users of social network 108. Furthermore, users of social network 108 may be incentivized to legally purchase content 104 (and not pirated content), since they may be able to make commissions from sales to their downline. They may also be encouraged to market content 104 by writing reviews, displaying items related to content 104 on their profiles, and develop a following of social network contacts who return to them for suggestions on which content to purchase.

Furthermore, the process of buying content in general may be improved, since users will be able to turn to specific social network contacts whom they trust to recommend content worthy of purchasing.

In some embodiments, users of system 100 may market their own user generated content with minimal costs, since they may leverage their social network contacts to distribute their content and collect commissions from all downline sales.

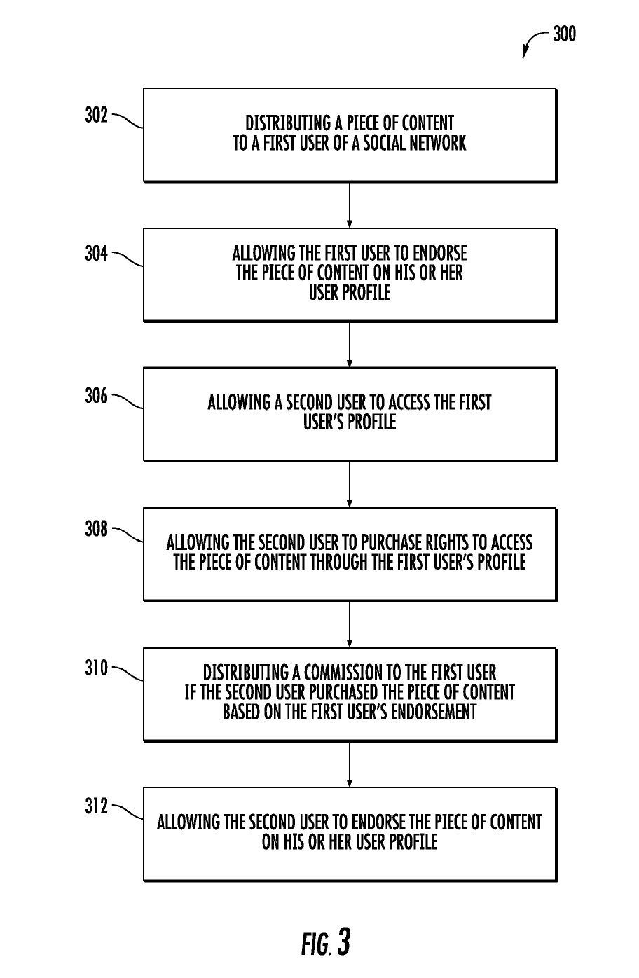

Referring now to FIG. 2, a system 200 is shown in accordance with one embodiment, wherein system 200 comprises a social network module 202 operative to host a social network 204, a network marketing content distribution module 206 that operates within social network 204, wherein network marketing content distribution module is operative to distribute a piece of content 208 to a first user 210 of social network 204, allow first user 210 to endorse content 208 on first user 210's user profile 212 that resides within network marketing content distribution module 206, allow a second user 214 to access first user's profile 212, allow second user 214 to purchase rights 216 to access content 208 through first user's profile 212, distribute a commission 218 to first user 210 if second user 214 purchased content 208 based on first user 210's endorsement, and allow second user 214 to endorse content 208 on second user's profile 220 that resides within network marketing content module 206.

The term “module,” as used herein, may refer to electronic hardware module, such as a PC, a processor, a network of computers, a server, and the like. Alternatively, the term “module” may refer to a computer software module, such as a computer application, or a set of computer executable instructions. In one embodiment, the term “module” may refer to a module that combines both hardware and software components, such as a computer or processor running computer executable instructions, such as a server running a network hosting application.

Social network module 202 may comprise a social network hosting server, a social network hosting application, or a combination thereof. Network marketing content distribution module 206 may comprise a network marketing content distribution application, a network marketing hosting application, a server that hosts or operates a content distribution or network marketing application, and the like. Network marketing content distribution module 206 may operate in or be accessed through social network 204.

In some embodiments, the term “social network,” “content,” “user,” “user profile,” and “network marketing,” may refer to those embodiments discussed above with reference to FIGS. 1A through 1G.

In a further embodiment, system 200 may comprise a user verification module that is operative to verify whether first user 210 or second user 214 has granted network marketing content distribution module 206 access to first user 210's or second user 214's social network account prior to allowing first user 210 or second user 14 access to network marketing content distribution module 206 or content 208. User verification module may comprise a prompt, which may include terms and conditions, which first user 210 or second user 214 may agree to.

In one embodiment, system 200 may comprise a user registration module that is operative to register first user 210 or second user 214 for an account with network marketing content distribution module 206. The account may be used to store information related to said user, such as identity, location, user content library, user status updates, and the like. The account may be linked to a user profile on the network marketing content distribution module 206, or a user profile on social network 204. The account may also contain financial information, such as payment information that first user 210 or second user 214 may use to pay for content 104 or rights to access content 216.

In yet another embodiment, system 200 may comprise a commission distribution module that is operative to mail a commission check 222 to first user 210. The commission distribution module may comprise a hardware and/or software module that prints out a check and mails it to first user 210, such as a printer, a envelope packager, a mailer, and the like.

In some embodiments, system 200 may comprise a digital rights management module, which may be operative to manage the digital rights associated with the distribution of content 208. In some embodiments, the digital rights management module may comprise any of the various embodiments of digital rights management systems described above with reference to FIGS. 1A through 1G.

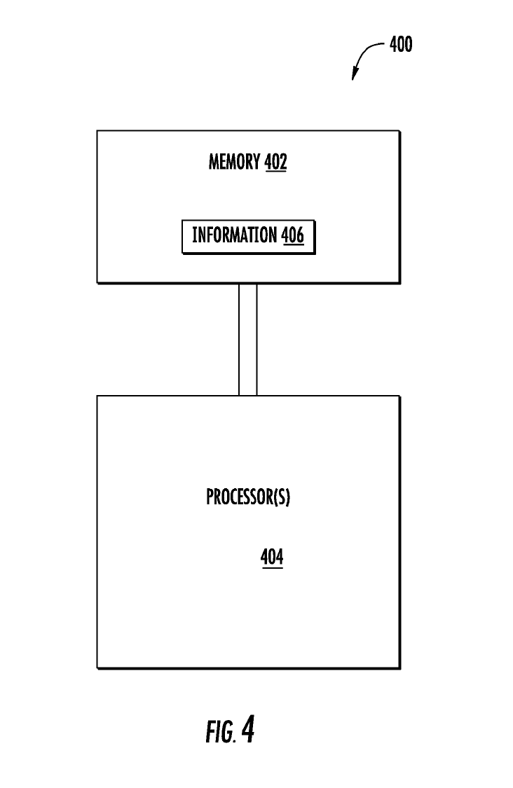

Referring now to FIG. 3, a method 300 is shown in accordance with one embodiment, wherein method 300 comprises using at least one processor to perform any or all of the following: distributing a piece of content to a first user of a social network (block 302), allowing the first user to endorse the piece of content on the first user's user profile (block 304), allowing a second user of the social network to access the first user's profile (block 306), allowing the second user to purchase rights to access the piece of content through the first user's profile (block 308), distributing a commission to the first user if the second user purchase the piece of content based on the first user's endorsement (block 310), and allowing the second user to endorse the piece of content on the second user's profile (block 312). In some embodiments, distributing a piece of content to a first user of a social network may comprise any of those embodiments of performing this step described above with reference to FIGS. 1A through 1G, and FIG. 2.

In some embodiments, allowing the first user to endorse the piece of content on the first user's user profile may comprise any of those embodiments of performing this step described above with reference to FIGS. 1A through 1G, and FIG. 2.

In some embodiments, allowing a second user of the social network to access the first user's profile may comprise any of those embodiments of performing this step described above with reference to FIGS. 1A through 1G, and FIG. 2.

In some embodiments, allowing the second user to purchase rights to access the piece of content through the first user's profile may comprise any of those embodiments of performing this step described above with reference to FIGS. 1A through 1G, and FIG. 2.

In some embodiments, distributing a commission to the first user if the second user purchase the piece of content based on the first user's endorsement may comprise any of those embodiments of performing this step described above with reference to FIGS. 1A through 1G, and FIG. 2.

In some embodiments, allowing the second user to endorse the piece of content on the second user's profile may comprise any of those embodiments of performing this step described above with reference to FIGS. 1A through 1G, and FIG. 2.

In some embodiments, method 300 may be carried out by computer executable instructions on a computer readable medium, wherein the computer executable instructions are operative to perform method 300.

### Hardware and Operating Environment

This section provides an overview of example hardware and the operating environments in conjunction with which embodiments of the inventive subject matter can be implemented.

A software program may be launched from a computer readable medium in a computer-based system to execute the functions defined in the software program. Various programming languages may be employed to create software programs designed to implement the systems 100, 200, and method 300 disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed regarding FIG. 4 below.

FIG. 4 is a block diagram representing an apparatus 400 according to various embodiments. Such embodiments may comprise a computer, a memory system, a magnetic or optical disk, some other storage device, or any type of electronic device or system. The apparatus 400 may include one or more processor(s) 404 coupled to a machine-accessible medium such as a memory 402 (e.g., a memory including electrical, optical, or electromagnetic elements). The medium may contain associated information 406 (e.g., computer program instructions, data, or both) which, when accessed, results in a machine (e.g., the processor(s) 404) performing the activities previously described herein.

The principles of the present disclosure may be applied to all types of computers, systems, and the like, include desktop computers, servers, notebook computers, personal digital assistants, microcomputers, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. A system comprising:
a. at least processor; and
b. computer executable instructions readable by the at least one processor and operative to:
i. distribute a piece of content to a first user of a social network;
ii. allow the first user to endorse the piece of content on the first user's user profile;
iii. allow a second user of the social network to access the first user's profile;
iv. allow the second user to purchase rights to access the piece of content through the first user's profile page;
v. distribute a commission to the first user if the second user purchased the piece of content based on the first user's endorsement; and
vi. allow the second user to endorse the piece of content on the second user's user profile.

2. The system of claim 1, wherein the processor is connected to, integrated with, or part of a server that hosts the social network

3. The system of claim 1, wherein the processor is connected to, integrated with, or part of a server that distributes the piece of content.

4. The system of claim 1, wherein distributing a piece of content to a first user of a social network comprises allowing the first user to purchase the piece of the content.

5. The system of claim 1, wherein distributing a piece of content to a first user of a social network comprises distributing the piece of content to the first user for free.

6. The system of claim 5, wherein distributing the piece of content to the first user for free comprises distributing the piece of content to the first user for free so long as the first user is an influential user of the social network.

7. The system of claim 1, wherein the piece of content comprises a piece of digital content.

8. The system of claim 1, wherein the allowing the first user to endorse the piece of content on his or her user profile comprises allowing the first user to endorse the piece of content to his or her social network contacts.

9. The system of claim 1, wherein the endorsement comprises a web link.

10. The system of claim 1, wherein the endorsement comprises a visual code.

11. The system of claim 1, wherein the computer executable instructions are operative to display a content library on the first user's profile, wherein the content library lists the piece of content or displays a link to the piece of content.

12. The system of claim 1, wherein allowing the second user to purchase rights to access the piece of content through the first user's profile comprises allowing the second user to purchase rights to download or stream the piece of content.

13. The system of claim 1, wherein distributing a commission to the first user comprises distributing a monetary commission to the first user, or distributing a credit-based commission to the first user.

14. The system of claim 1, wherein distributing a commission to the first user comprises mailing a commission check to the first user.

15. The system of claim 1, wherein the computer executable instructions are operative to distribute a fee to a content distributor whenever the piece of content is purchased.

16. The system of claim 1, wherein the computer executable instructions are operative to display the first user's identity along with the piece of content or the content's endorsement on the second user's profile.

17. The system of claim 1, wherein the computer executable instructions are operative to require the first user to install, open, access, authorize, or opt into a social network application prior to distributing the piece of content to the first user.

18. The system of claim 17, wherein the social network application comprises an application that operates within a social network environment.

19. The system of claim 1, further comprising requiring that the second user install, open, access, authorize, or opt into a social network application prior to purchasing the piece of content.

20. The system of claim 19, wherein the social network application comprises an application that operates within a social network environment.

21. The system of claim 1, wherein the computer executable instructions are further operative to host a digital rights management system to manage the distribution of the piece of content and prevent unauthorized access, distribution, or copying of the piece of content.

22. The system of claim 1, wherein the computer executable instructions are further operative to allow the first user or the second user to link their social network account with a third party social network provider.

23. A system comprising:
a. a social network module operative to host a social network;
b. a network marketing content distribution module that operates within the social network, wherein the network marketing content distribution application module is operative to:
i. distribute a piece of content to a first user of a social network;
ii. allow the first user to endorse the piece of content on the first user's user profile that resides within the network marketing content distribution module;
iii. allow a second user of the social network to access the first user's profile;
iv. allow the second user to purchase rights to access the piece of content through the first user's profile;
v. distribute a commission to the first user if the second user purchased the piece of content based on the first user's endorsement; and
vi. allow the second user to endorse the piece of content on his or her user profile that resides within the network marketing content distribution module.

24. The system of claim 23, further comprising a user verification module that is operative to verify whether the first user or the second user has granted the network marketing content distribution module access to the first user's or the second user's social network account prior to allowing the first user or the second user access to the network marketing content distribution module or to the piece of content.

25. The system of claim 23, further comprising a user registration module that is operative to register the first user or the second user for an account with the network marketing content distribution module.

26. The system of claim 23, further comprising an account linking module that is operative to allow the first user or the second user to link their social network accounts with their network marketing content distribution module accounts.

27. The system of claim 23, further comprising a commission distribution module that is operative to mail a commission check to the first user.

28. A method comprising:
a. using at least one processor to perform any or all of the following:
i. distributing a piece of content to a first user of a social network;
ii. allowing the first user to endorse the piece of content on the first user's user profile;
iii. allowing a second user of the social network to access the first user's profile;
iv. allowing the second user to purchase rights to access the piece of content through the first user's profile;
v. distributing a commission to the first user if the second user purchased the piece of content based on the first user's endorsement; and
vi. allowing the second user to endorse the piece of content the second user's user profile.

29. A computer readable medium comprising computer executable instructions that are operative to:
a. use at least one processor to perform any or all of the following:
i. distributing a piece of content to a first user of a social network;
ii. allowing the first user to endorse the piece of content on the first user's user profile;
iii. allowing a second user of the social network to access the first user's profile;
iv. allowing the second user to purchase rights to access the piece of content through the first user's profile;
v. distributing a commission to the first user if the second user purchased the piece of content based on the first user's endorsement; and
vi. allowing the second user to endorse the piece of content on the second user's user profile.
